(19) United States
(12) Patent Application Publication
(10) Pub. No.: US 2006/0156251 A1
(43) Pub. Date: Jul. 13, 2006

(54) System and method for providing feature customization for a communications device based on an active communications session

(76) Inventors: Atiya Suhail, Plano, TX (US); Kashipati G. Rao, Plano, TX (US); Timucin Ozugur, Garland, TX (US); Jack Jachner, Plano, TX (US); Sudheer Mamidipaka, Redmond, WA (US); Snehal Desai, Richardson, TX (US)

Correspondence Address: ALCATEL USA;INTELLECTUAL PROPERTY DEPARTMENT, 3400 W. PLANO PARKWAY, MS LEGL2, PLANO, TX, 75075, US

(21) Appl. No.: 11/017,434

(22) Filed: Dec. 20, 2004

(51) Int. Cl. G06F 17/00; H04L 12/66; G06F 3/00

(52) U.S. Cl. 715/809; 370/352

(57) ABSTRACT

System and method for providing feature customization for a communications device based on an active communications system are described. One embodiment is a method in a voice terminal for customizing applications in response to an active call comprising assigning at least one category to each of a plurality of entries in an application file; determining a category associated with an active call; a and reconfiguring a GUI of the application to highlight a display of entries associated with the category associated with the active call. Another embodiment is a method of customizing a desktop of a computer system in response to an outgoing call from the computer system comprising determining a context of the outgoing call; activating at least one of a plurality of desktop customization units based on the determined context; and responsive to the activating, customizing the desktop in accordance with the determined context.

### BACKGROUND OF THE INVENTION

1. Technical Field of the Invention

The present invention generally relates to communications devices. More particularly, and not by way of any limitation, the present invention is directed to system and method for providing feature customization on such communications devices based on the communications session that is currently active.

2. Description of Related Art

Voice over Internet Protocol (“VoIP”) and wireless communications devices, such as mobile phones, (hereinafter collectively referred to as “enhanced phones”) are more rich in features than public switched telephone network (“PSTN”) telephones. For example, most enhanced phones include an address book and calendar function. Many also include electronic mail (“email”) capability. Accordingly, there may be many instances in which an enhanced phone user may want to browse the address book, check the calendar, or search for a particular email communication during voice communications. For example, if the person with whom the user is talking would like the phone number of a mutual acquaintance, the user might access the phone's address book to access the phone number of the acquaintance and communicate it to the person verbally. Similarly, the person with whom the user is talking may wish to confirm a previously established appointment, in which case it would be helpful for the user to be able to access phone's calendar and locate the appointment for discussion purposes. Additionally, the person with whom the user is talking may wish to discuss issues raised in an email previously sent to the user. In this situation, it would be beneficial to the user to be able to quickly and easily locate the email in question.

Unfortunately, it may be difficult for the user to sift through all of the extraneous information in order to find the information that might be relevant to the current communication. For example, there the user's calendar may have hundreds of entries stored therein, some of which may be personal, others of which may be professional, so to go through them one-by-one would be extremely tedious and may be ultimately unproductive. Similarly, the user's address book may have thousands of contacts stored therein; again, some of these contacts may be personal, others professional. Moreover, within these broad categories of “personal” and “professional” sub-categories may be drawn. For example, personal appointments or contacts may relate to friends, family, church, or other organizations. Similarly, professional appointments or contacts may be subdivided into different tasks or work groups.

A related situation is that of a computer desktop environment with integrated telephony capability. In one such environment, information related to a caller, such as call logs, project information, relevant documents, and so on, may be populated in a desktop environment of a called party user. A desktop environment can include several portals supported by well-known portal server technology. A portal is primarily a user interface (“UI”) framework for integrating other applications, content, and business processes, each of which may include several additional features that add value to the integrated environment. Such features may include, for example, search functionality and single sign-on functionality.

In general, a portal is a customizable desktop UI that is displayed in a standard Internet HTTP browser. It contains information and functionality aggregated together from multiple source sites, applications and/or datastores. It supports a single sign-on model that does not require separate sign-on procedures for all of the aggregated content of the portal.

Additionally, a desktop management system provides a dynamic work environment with integrated collaboration capabilities that help people perform their jobs more productively. This includes applications such as e-mail, instant messaging, web conferencing, and e-learning, which may be implemented using the portal technology.

### SUMMARY OF THE INVENTION

One embodiment is a method in a voice terminal for customizing applications in response to an active call. The method comprises assigning at least one category to each of a plurality of entries in an application file; determining a category associated with an active call; a and reconfiguring a GUI of the application to highlight a display of entries associated with the category associated with the active call.

Another embodiment is a system in a voice terminal for customizing applications in response to an active call. The system comprises means for assigning at least one category to each of a plurality of entries in an application file; means for determining a category associated with an active call; and means for reconfiguring a GUI of the application to highlight a display of entries associated with the category associated with the active call.

Another embodiment is a system in a voice terminal for customizing applications in response to an active call. The system comprises a customization controller (“CC”) for controlling an application customization process; a configuration manager (“CM”) invoked by the CC responsive to a user adding an entry in an application; a feature customizer (“FC”) invoked by the CC in response to an active call.

Another embodiment is a method of customizing a desktop of a computer system in response to an outgoing call from the computer system. The method comprises determining a context of the outgoing call; activating at least one of a plurality of desktop customization units based on the determined context; and responsive to the activating, customizing the desktop in accordance with the determined context.

Another embodiment is an apparatus for customizing a desktop of a computer system in response to an outgoing call from the computer system. The apparatus comprises means for determining a context of the outgoing call; means for activating at least one of a plurality of desktop customization units based on the determined context; and means responsive to the activating for customizing the desktop in accordance with the determined context.

Another embodiment is an apparatus for customizing a desktop of a computer system in response to an outgoing call from the computer system. The apparatus comprises

a telephony unit for determining a context of the o outgoing call; a plurality of desktop customization units connected to the telephony unit; wherein the telephony unit activates at least one of the desktop customization units based on the determined context and wherein the activated at least one desktop customization unit customizes the desktop in accordance with the determined context.

### BRIEF DESCRIPTION OF THE DRAWINGS

A more complete understanding of the present invention may be had by reference to the following Detailed Description when taken in conjunction with the accompanying drawings wherein:

FIG. 1 illustrates a display of an Address Book in accordance with one embodiment;

FIG. 2 illustrates a display of a Calendar in accordance with one embodiment;

FIG. 3 is a block diagram of an system for implementing feature customization based on an active call in accordance with one embodiment;

FIG. 4 is a flowchart of the operation of the system of FIG. 3 in accordance with one embodiment;

FIG. 5 is a block diagram a system for implementing computer application and desktop management based on a telephone call in accordance with another embodiment;

FIG. 6 is a flowchart illustrating operation of the system of FIG. 5 in connection with a call made by a user to an IVR system; and

FIGS. 7A and 7B illustrate a flowchart of the operation of the system of FIG. 5 in connection with an outgoing call made by a user who has the option of providing a call subject in connection with the outgoing call.

### DETAILED DESCRIPTION OF THE DRAWINGS

Embodiments of the invention will now be described with reference to various examples of how the invention can best be made and used. Like reference numerals are used throughout the description and several views of the drawings to indicate like or corresponding parts, wherein the various elements are not necessarily drawn to scale.

A primary goal of one embodiment is to make the simple features in VoIP and mobile phones richer by customizing them based on an active call. “Address Book” and “Calendar” are two features that are available on most of the VoIP and mobile phones and are extensively used. By making these features customizable, their useablilty can be improved and the end-user provided with a rich feature experience.

In one embodiment, the Address Book and Calendar features of VoIP and mobile phones are customized based on an active call. In particular, a user's Address Book is sorted in an order such that the phone numbers relevant to an active call are easily available. For example, consider that a user is talking to another member of a project team of which the user is also a member. In this case, in accordance with one embodiment as described in greater detail below, the contact information for all of the project team members will be grouped together and this group moved to the top of the Address Book. Additionally, all of the appointments and meetings relevant to the project are highlighted in the user's Calendar. As a result, a user can achieve better organization and improve his or her efficiency.

In one embodiment, customization of such features is achieved as follows. Each entry in the Address Book can be assigned to belong to one or more of several categories. Examples of such categories may include “family,” “friends,” “colleagues,” “project A team member,” and so on. In one implementation, several default categories will be provided to a user, at which point the user can simply use them as is, modify them, or create new categories. For example, the user may want to add a category for people with whom he plays soccer (“soccer”) or a category “stores” comprising contact information for favorite places to shop. In essence, a user can have as many categories as he desires. Within a category, entries can be listed alphabetically by contact name.

As previously indicated, Address Book entries may be associated with one or more categories in the Address Book. If the entry is associated with more than one category, the user will be required to assign a weight for the entry with respect to each category. For example, the user may have a friend (“Bob Smith”) who is also a project team member. In this case, the user can associate the Address Book entry for Bob Smith with both a “friends” category and a “project team” category, assigning a weight for each category; for example, “1” for “friends” and “2” for “colleagues”. As described herein, the higher the number, the higher the weight, and the higher the priority. As a result, when the user is engaged in a voice conversation with Bob Smith, the project team group will be listed first, and the friends group will be listed second, with Bob Smith's name being listed first in both groups.

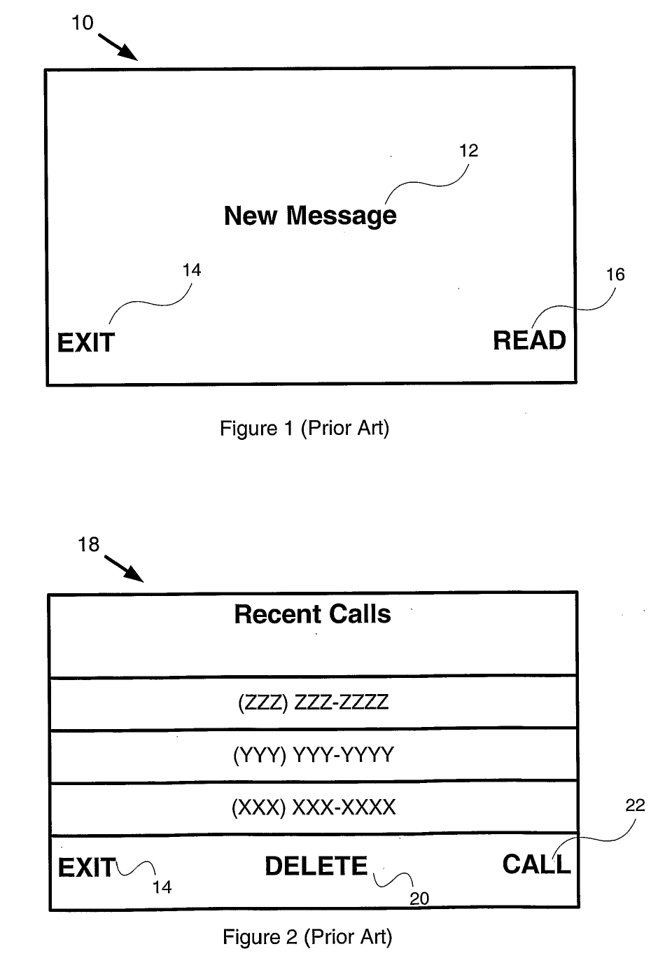

FIG. 1 illustrates a display 100 of the Address Book in the above-described example. In particular, a list of contacts in the project team category 101 is displayed first, a list of contacts in the friends category 102 is displayed next, and a list of contacts in a remaining category (“family”) 104 is displayed next.

In the implementation described above, the weights are assigned statically. However, if there is a call subject associated with a call, key words can be extracted from the subject line to assign the weights dynamically. For example, if the subject of the call is “Party on Friday”, the category “friends” is likely more relevant to this particular conversation with Bob Smith than is the category “project team”. The keyword “party” can be extracted from the subject line and used to assign a greater weight to the friends category in this case.

Similarly, each entry in the Calendar is associated with one of the categories defined in the Address Book. Specifically, any time a user makes an entry in the Calendar, the user may assign one or more categories (with weights, in the case of multiple categories for an entry) to the entry as described above with reference to the Address Book. Whenever there is an active call, all of the appointment, meeting, reminder, etc., entries in the Calendar associated with the category of the called (in the case of an outgoing call) or calling (in the case of an incoming call) party are highlighted. FIG. 2 illustrates a display 200 of the user's Calendar with team-related appointments 202 highlighted when the user is talking with a team member at work. Other (non-relevant) appointments 204 are greyed out.

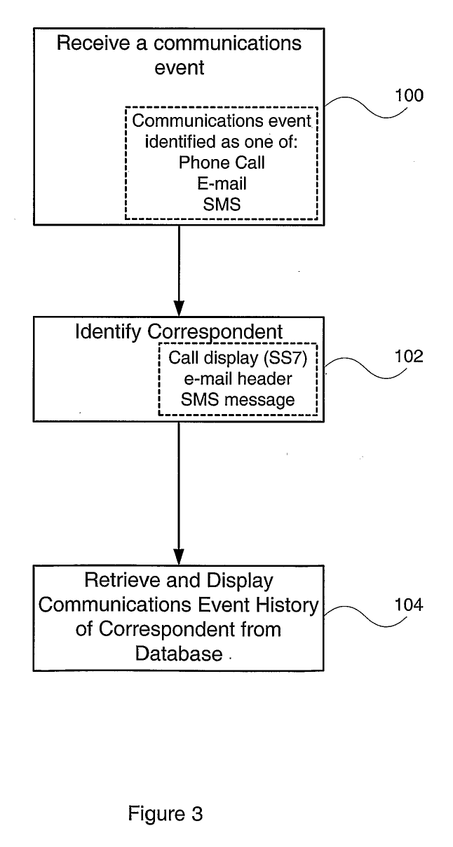

FIG. 3 illustrates a block diagram of an system 300 for implementing feature customization based on an active call in accordance with one embodiment. The system 300 comprises a customization controller (“CC”) 302 that controls the features customization process. The CC 302 invokes a configuration manager (“CM”) 304 when a user adds an entry in his Address Book or Calendar. Whenever there is an active call, the CC 302 passes to the CM 304 the name of the caller or callee and retrieves therefrom the category for the name. If there is more than one category for the name, the weights for each of those categories are also determined. The CC 302 then invokes a feature customizer (“FC”) 306 and passes to it the category or categories and weight (if any) associated with each. A repository 308 is a shared entity that stores an address book application 310, which comprises all of the user's Address Book entries, and a configuration file 312 containing configuration information for each of the entries in the address book database 310.

The FC 306 receives the category or categories and associated weight for each category (if applicable) from the CC 302 and customizes the address book application 310 and a calendar application 314. In one embodiment, the FC 306 also passes each category and weight (if applicable) to an electronic mail (“email”) application 316, which uses the information to display all emails related to the category, and a call log application 318, which uses the information to display a log of all previous calls to or from the caller/callee.

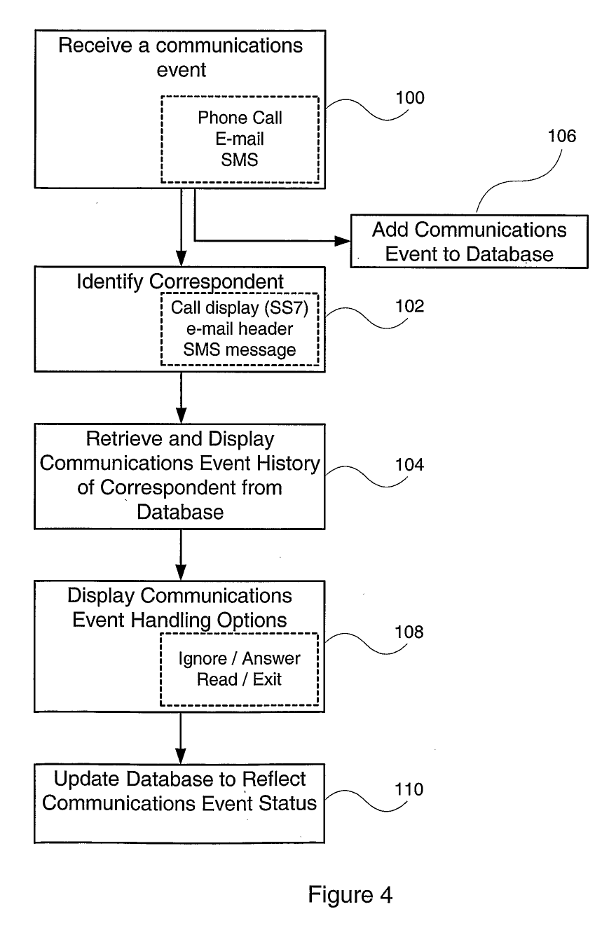

The steps involved in implementing feature customization as described herein are illustrated in FIG. 4. In step 400, a call is made to (incoming call) or from (outgoing call) a user. In step 402, a determination is made whether the call is an incoming or an outgoing call. If it is determined that the call is an outgoing call, execution proceeds to step 404, in which the name of the called party is obtained; otherwise, execution proceeds to step 406, in which the name of the calling party is obtained. Execution proceeds from step 404 or step 406 to step 408, in which one or more categories associated with the called or calling party is obtained from the configuration file 312 (FIG. 3). In step 410, a determination is made whether there is only one category associated with the called or calling party. If so, execution proceeds to step 414, in which all of the names within the category are moved to the top of the address book. In step 416, all of the appointments associated with the category in the Calendar are highlighted. In step 418, all e-mails related to the category are displayed. Additionally, a log of all calls associated with the category are displayed.

If in step 410 it is determined that the called party or calling party is associated with more than one category, execution proceeds to step 420, in which the weight of each category is determined. In step 422, the entries associated with the categories are moved to the top of the address book and sorted in decreasing order of priority as indicated by the weight associated with the category with respect to the called or calling party. In step 424, the appointments associated with the categories are highlighted, with visual cues being used to differentiate among the categories and further indicate the associated weight thereof. In step 426, emails and call logs associated with the categories are displayed in decreasing order of priority as indicated by the weight associated with the category with respect to the called or calling party.

In step 428, a determination is made whether the call has been terminated. If not, execution remains in step 428 until the call is terminated; otherwise, execution proceeds to step 430. In step 430, the display reverts to its default mode; e.g., the address Book entries are displayed in alphabetical order, no highlighting appears in the Calendar, and emails and call log entries are displayed in chronological order. It will be recognized that the “default” display for each of the foregoing may be selectively changed by the user. Execution ends in step 432.

It should be noted that any time a new party is “conferenced in” on a call as it proceeds as illustrated in FIG. 4, the category or categories associated with the new party will be obtained from the configuration file 312, as occurs with the original caller/callee in step 408, and then steps 410-428 will be executed with reference to the category or categories associated with all of the call participants (i.e., the original caller/callee and any new parties). Similarly, if a party is dropped from the call, steps 410-428 will be re-executed with reference to the category or categories associated with all of the remaining call participants.

Accordingly, the forgoing embodiment as described above provides a system and method for providing feature customization for enhanced phones based on an active call.

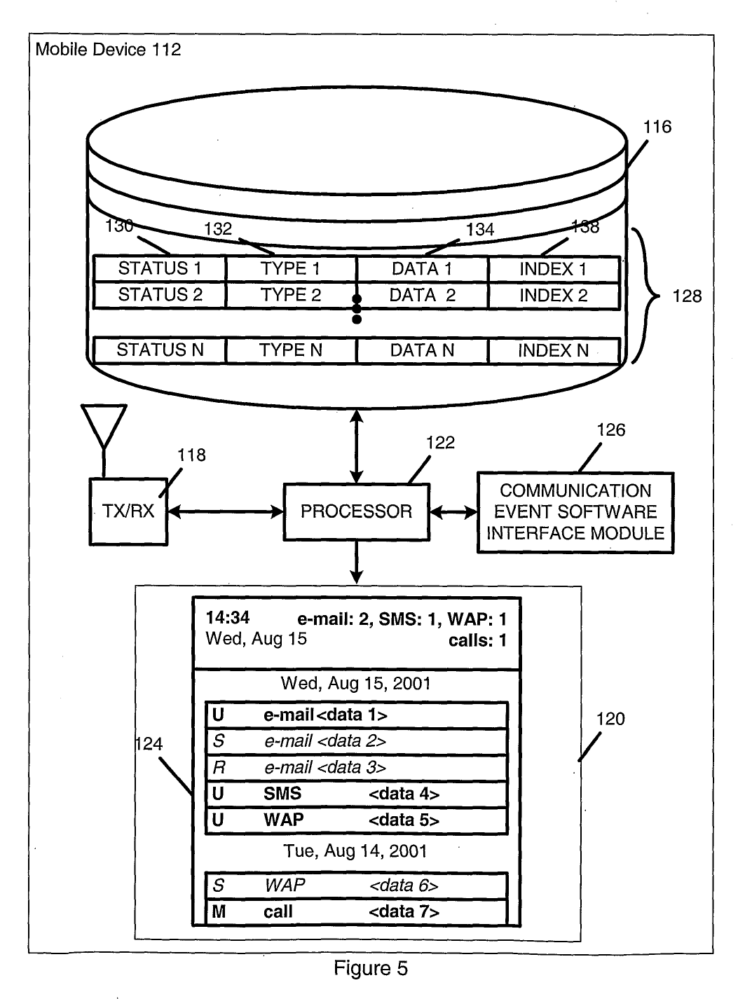

FIG. 5 is a block diagram of another embodiment comprising a system 500 for implementing computer application and desktop management based on a telephone call. As shown in FIG. 5, the system 500 comprises a content aggregation unit 502, an application integration unit 504, and a team collaboration unit 506 for implementing a portal 508 displayed to a user. It will be recognized that the portal 508 may comprise a plurality of portlets 510(1)-510(5) for organizing information to be displayed to the user. The units 502, 504, and 506 will likely reside one or more servers 511. In accordance with features of one embodiment, a telephony unit 512 is connected to each of the units 502, 504, 506.

The telephony unit 512 comprises all of the telephony functionality for implementing the embodiment described herein for performing application and desktop management based on an active call, as will be described in greater detail below. In general, the telephony unit 512 is cognizant of all telephony events that are performed with respect to the system 500. The telephony unit 512 uses these telephony events to determine which of the units 502, 504, 506 to activate. The telephony unit 512 is further connected to one or more of a PBX system 520, an Interactive Voice Response (“IVR”) system 522, and a class 5 switch 524 to enable it to obtain information regarding telephony events.

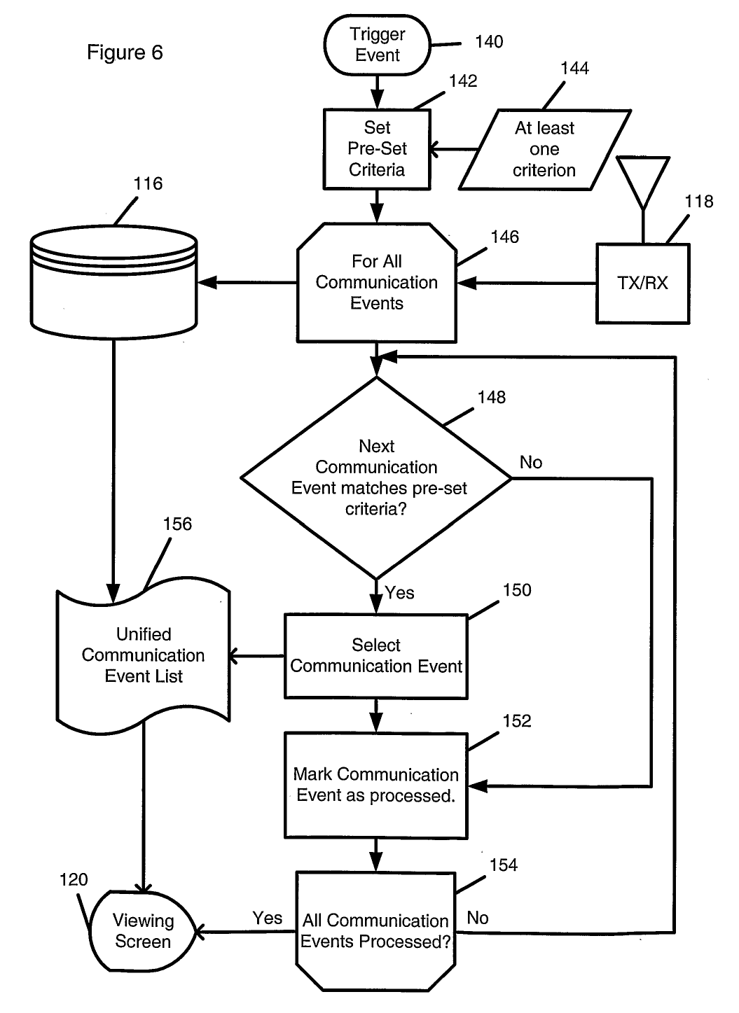

FIG. 6 is a flowchart illustrating operation of the system 500 in connection with a call made by a user to an IVR system, such as the system 522. It will be recognized that, for purposes of the flowchart shown in FIG. 6, the IVR system may be internal, such as in a Help Desk implementation, or External, such as in a travel agency implementation. Execution begins in step 600, in which a user dials in to an IVR system, such as the system 522. In step 602, the IVR system answers the call and prompts the user to select one of several options. For example, in a Help Desk implementation, the options may include: “Dial 1 for software support; Dial 2 for hardware support” and so on. In a travel agency implementation, the options may include “Dial 1 for domestic travel; Dial 2 for international travel” and so on.

In step 604, a determination is made whether the user selected an option in response to the prompts issued in step 602. If it is determined in step 604 that the user did not select an option, execution remains at step 604 until the user selects an option, at which point, execution proceeds to step 606. For purposes of example, it will be assumed that the user selected the software support option by dialing 1 in response to the prompts. In step 606, the IVR system 522 advises the telephony unit 512 that the user requested software support. In step 608, the telephony unit 512 determines which one or more of the units 502, 504, 506, to activate. In one embodiment, as illustrated in FIG. 5, options include the content aggregation unit 502, the application integration unit 504, and the team collaboration unit 506, some combination of those units, or none of the units.

If a determination is made by the telephony unit 512 to activate the team collaboration unit 506, execution proceeds to step 610, in which the team collaboration unit automatically arranges the contact list within the user's messenger. For example, contact information for software support people who are available at the given time, as well as contact information for other support people who have helped the user on previous tickets, are automatically temporarily added to the user's contact list.

If a determination is made by the telephony unit 512 to activate the application integration unit 504, execution proceeds to step 612. In step 612, the application integration unit 504 allows automatically logs the user on to a secure Help Desk site without requiring him or her to enter a user ID or password. This enables the user to view and place requests related to open software support tickets, for example.

If a determination is made by the telephony unit 512 to activate the content aggregation unit 502, execution proceeds to step 614. In step 614, the content aggregation unit 502 aggregates a variety of information related to the user, such as any previous software tickets opened by the user, currently open tickets, corporate software warnings, etc., and posts this aggregated information on the related portal 508. Following execution of steps 610, 612, and/or 614, or if none of the blocks are activated in step 608, execution proceeds to step 616.

In step 616, a determination is made whether the IVR system 522 has provided any new options. If not, execution proceeds to step 618, in which a determination is made whether the user has disconnected the call. If not, execution returns to step 616; otherwise, execution proceeds to step 620, in which the desktop, or portal, is returned to its previous or default state. If a positive determination is made in step 616, execution returns to step 604 and the process repeats.

It will be recognized that, in some instances, when a user calls another party, he or she can send a “call subject line” associated with the call using Instant Messaging (“IM”) or Short Message Service (“SMS”). In such instances, the portal 508 can be populated with information related to the call subject. For example, if a project is mentioned in the call subject line, the portal 508 could be populated with one or more documents related to the project. If the call subject line relates to scheduling a meeting, a calendar application could be opened in the portal 508 to enable the user to schedule the meeting. Additionally, if the populated information is an application that requires the user to log in, the system 500 automatically logs the user in.

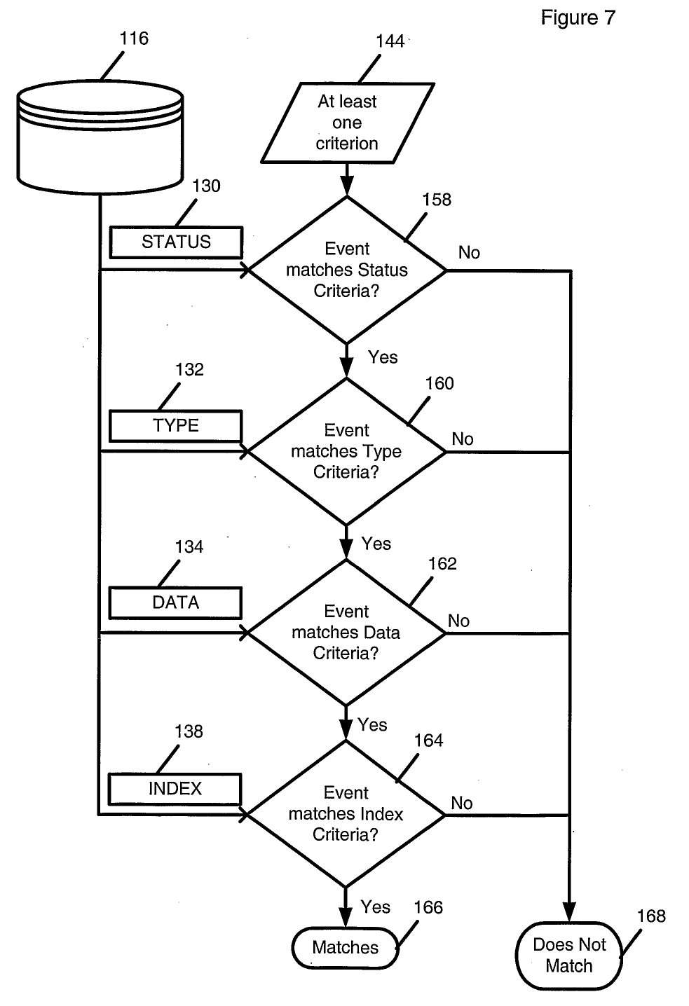

FIGS. 7A and 7B illustrate a flowchart illustrating operation of the system 500 in connection with an outgoing call made by a user who has the option of providing a call subject in connection with the outgoing call.

Execution begins in step 700 in which a user calls Person A. In step 702, a determination is made whether a call subject line has been provided in connection with the call. If so, execution proceeds to step 704, in which the call subject information is forwarded to the telephony unit 512. It will be assumed for the sake of example herein that the subject line mentions “Project X”. In step 708, the telephony unit 512 determines which one or more of the units 502, 504, 506, to activate. In one embodiment, as illustrated in FIG. 5, options include the content aggregation unit 502, the application integration unit 504, and the team collaboration unit 506, some combination of those units, or none of the units.

If a determination is made by the telephony unit 512 to activate the team collaboration unit 506, execution proceeds to step 710, in which the team collaboration unit automatically arranges the contact list within the user's messenger. In particular, contact information for Person A is automatically temporarily added to the user's contact list.

If a determination is made by the telephony unit 512 to activate the application integration unit 504, execution proceeds to step 712. In step 712, the application integration unit 504 allows automatically logs the user on to secure sites without requiring him or her to enter a user ID or password. This enables the user to view documents and information related to Project X and Person A if allowed.

If a determination is made by the telephony unit 512 to activate the content aggregation unit 502, execution proceeds to step 714. In step 714, the content aggregation unit 502 aggregates a variety of information, documents, and/or presentations related to Project X, as well as information, about Person A, and posts the aggregated information on the related portal 508. Following execution of steps 710, 712, and/or 714, or if none of the blocks are activated in step 708, execution proceeds to step 716.

In step 716, a determination is made whether the user has disconnected the call. If not, execution returns to step 716; otherwise, execution proceeds to step 718, in which the desktop, or portal, is returned to its previous or default state.

Returning to step 702, if a negative determination is made in that step, execution proceeds to step 720 (FIG. 7B). In step 720, the telephony unit 512 determines which one or more of the units 502, 504, 506, to activate. In one embodiment, as illustrated in FIG. 5, options include the content aggregation unit 502, the application integration unit 504, and the team collaboration unit 506, some combination of those units, or none of the units.

If a determination is made by the telephony unit 512 to activate the team collaboration unit 506, execution proceeds to step 722, in which the team collaboration unit automatically arranges the contact list within the user's messenger. In particular, contact information for Person A is automatically temporarily added to the user's contact list.

If a determination is made by the telephony unit 512 to activate the application integration unit 504, execution proceeds to step 724. In step 724, the application integration unit 504 allows automatically logs the user on to secure sites without requiring him or her to enter a user ID or password. This enables the user to view documents and information related to Person A if allowed.

If a determination is made by the telephony unit 512 to activate the content aggregation unit 502, execution proceeds to step 726. In step 726, the content aggregation unit 502 aggregates a variety information, about Person A and posts the aggregated information on the related portal 508. Following execution of steps 722, 724, and/or 726, or if none of the blocks are activated in step 720, execution returns to step 716 (FIG. 7A).

Accordingly, the embodiments described herein provide systems and methods for customizing display features of a communications device based on characteristics of an active call.

It should be noted that, although the embodiments have been described with reference to SIP, other protocols may be appropriate for use with the embodiments. Moreover, it will be recognized that subscription to selected presentities will be performed in accordance with the selected protocol.

It is believed that the operation and construction of the present invention will be apparent from the Detailed Description set forth above. While the exemplary embodiments of the invention shown and described have been characterized as being preferred, it should be readily understood that various changes and modifications could be made therein without departing from the scope of the present invention as set forth in the following claims.

What is claimed is:

1. A method in a voice terminal for customizing applications in response to an active call, the method comprising:
assigning at least one category to each of a plurality of entries in an application file;
determining a category associated with an active call; and
reconfiguring a GUI of the application to highlight a display of entries associated with the category associated with the active call.

2. The method of claim 1 wherein the reconfiguring comprises displaying entries to which have been assigned the category associated with the active call more prominently in the GUI than other entries.

3. The method of claim 1 further comprising:
assigning at least two categories to at least one entry in the application file; and
assigning a weight to each of the at least two categories assigned to the at least one entry.

4. The method of claim 3 wherein the active call has at least two categories associated therewith, the determining further comprising determining a weight associated with each of the at least two categories associated with the active call and the reconfiguring further comprising displaying entries to which have been assigned one of the categories associated with the active call in a manner indicative of the relative weight of the categories assigned to the entries.

5. The method of claim 3 wherein the assigning a weight comprises dynamically assigning a weight to each of the at least two categories assigned to the at least one entry based on a subject of the active call.

6. The method of claim 1 wherein the application comprises a calendar application.

7. The method of claim 6 wherein the GUI comprises a calendar display and the reconfiguring comprises highlighting in a calendar display entries to which the determined category has been assigned.

8. The method of claim 1 wherein the application comprises an address book application.

9. The method of claim 8 wherein the GUI comprises an address book listing and the reconfiguring comprises displaying entries to which the determined category has been assigned at a beginning of an address book listing.

10. The method of claim 1 wherein the application comprises a call log application.

11. The method of claim 10 wherein the reconfiguring comprises displaying entries to which the determined category has been assigned at the beginning of a call log listing.

12. The method of claim 1 wherein the application comprises an email application.

13. The method of claim 12 wherein the reconfiguring comprises displaying entries to which the determined category has been assigned at the beginning of an email message listing.

14. The method of claim 1 further comprising, responsive to addition of a new party to the active call:
determining a category associated with the new party;
responsive to the category associated with the new party differing from the category associated with the active call, determining a weight assigned to each of the categories;
wherein the reconfiguring further comprises displaying entries to which one of the categories has been assigned in a manner indicative of the relative weights assigned to the categories.

15. A system in a voice terminal for customizing applications in response to an active call, the system comprising:
means for assigning at least one category to each of a plurality of entries in an application file;
means for determining a category associated with an active call; and
means for reconfiguring a GUI of the application to highlight a display of entries associated with the category associated with the active call.

16. The system of claim 15 wherein the means for reconfiguring comprises means for displaying entries to which have been assigned the category associated with the active call more prominently in the GUI than other entries.

17. The system of claim 15 further comprising:
means for assigning at least two categories to at least one entry in the application file; and
means for assigning a weight to each of the at least two categories assigned to the at least one entry.

18. The system of claim 17 wherein the means for assigning a weight comprises means for dynamically assigning a weight to each of the at least two categories assigned to the at least one entry based on a subject of the active call.

19. The system of claim 17 wherein the active call has at least two categories associated therewith, the means for determining further comprising means for determining a weight associated with each of the at least two categories associated with the active call and the means for reconfiguring further comprising displaying entries to which have been assigned one of the categories associated with the active call in a manner indicative of the relative weight of the categories assigned to the entries.

20. The system of claim 15 wherein the application comprises a calendar application and the GUI comprises a calendar display and wherein the means for reconfiguring comprises means for highlighting in a calendar display entries to which the determined category has been assigned.

21. The system of claim 15 wherein the application comprises an address book application and the GUI comprises an address book listing and wherein the means for reconfiguring comprises means for displaying entries to which the determined category has been assigned at a beginning of an address book listing.

22. The system of claim 15 wherein the application comprises a call log application and the means for reconfiguring comprises means for displaying entries to which the determined category has been assigned at the beginning of a call log listing.

23. The system of claim 15 wherein the application comprises an email application and the means for reconfiguring comprises means for displaying entries to which the determined category has been assigned at the beginning of an email message listing.

24. The system of claim 15 further comprising:
means responsive to addition of a new party to the active call for determining a category associated with the new party and, responsive to the category associated with the new party differing from the category associated with the active call, determining a weight assigned to each of the categories;
wherein the means for reconfiguring further comprises means for displaying entries to which one of the categories has been assigned in a manner indicative of the relative weights assigned to the categories.

25. A system in a voice terminal for customizing applications in response to an active call, the system comprising:
a customization controller (“CC”) for controlling an application customization process;
a configuration manager (“CM”) invoked by the CC responsive to a user adding an entry in an application;
a feature customizer (“FC”) invoked by the CC in response to an active call.

26. The system of claim 25 further comprising a shared entity comprising:
an address book application comprising a plurality of address book entries; and
a configuration file containing configuration information for each of the address book entries.

27. The system of claim 25, wherein responsive to an active call, the CC passes to the CM a name of a called or calling party and retrieves therefrom the category for the name.

28. The system of claim 27 wherein, if there is more than one category for the name, the CC also retrieves from the CM a weight for each of the more than one category.

29. The system of claim 28 wherein the FC receives the category from the CC and customizes a GUI of the address book application.

30. The system of claim 28 further comprising an email application, wherein the FC receives the category from the CC and customizes a GUI of email application.

31. The system of claim 28 further comprising a call log application, wherein the FC receives the category from the CC and customizes a GUI of the call log application.

32. The system of claim 28 further comprising a calendar application, wherein the FC receives the category from the CC and customizes a GUI of the calendar application.

33. A method of customizing a desktop of a computer system in response to an outgoing call from the computer system, the method comprising:
determining a context of the outgoing call;
activating at least one of a plurality of desktop customization units based on the determined context; and
responsive to the activating, customizing the desktop in accordance with the determined context.

34. The method of claim 33 wherein the outgoing call is placed to an interactive voice response (“IVR”) system, the method further comprising the user selecting an option provided by the IVR system.

35. The method of claim 34 wherein the determining is performed using the IVR option selected by the user.

36. The method of claim 33 wherein the outgoing call includes a call subject line.

37. The method of claim 36 wherein the call subject line is delivered using a method selected from a group of methods consisting of instant messaging, text messaging, and short message service (“SMS”) messaging.

38. The method of claim 36 wherein the determining is performed using the call subject line and an identity of a called party.

39. The method of claim 33 wherein the activating comprises activating a team collaboration unit and the customizing comprises updating and arranging a user contact list.

40. The method of claim 33 wherein the customizing further comprises activating an application integration unit and the customizing comprises enabling user access to one or more applications.

41. The method of claim 33 wherein the activating comprises activating a content aggregation unit and the customizing further comprises:
aggregating information related to the context; and
posting the aggregated information on the desktop.

42. Apparatus for customizing a desktop of a computer system in response to an outgoing call from the computer system, the apparatus comprising:
means for determining a context of the outgoing call;
means for activating at least one of a plurality of desktop customization units based on the determined context; and
means responsive to the activating for customizing the desktop in accordance with the determined context.

43. The apparatus of claim 42 further comprising an IVR unit for prompting the user to select one of a plurality of IVR options and a telephony unit for receiving an indication of an IVR option selected by the user.

44. The apparatus of claim 43 wherein the means for determining uses the IVR option selected by the user.

45. The apparatus of claim 42 wherein the outgoing call includes a call subject line.

46. The apparatus of claim 45 wherein the call subject line is delivered using a method selected from a group of methods consisting of instant messaging, text messaging, and short message service (“SMS”) messaging.

47. The apparatus of claim 45 wherein the means for determining uses the call subject line and an identity of a called party.

48. The apparatus of claim 42 wherein the means for activating comprises a telephony unit.

49. The apparatus of claim 42 wherein the means for customizing comprises an application integration unit for enabling user access to one or more applications.

50. The apparatus of claim 42 means for customizing comprises a content aggregation unit for aggregating information related to the context and posting the aggregated information on the desktop.

51. The apparatus of claim 42 wherein the means for customizing comprises a team collaboration unit for updating and arranging a user contact list.

52. Apparatus for customizing a desktop of a computer system in response to an outgoing call from the computer system, the apparatus comprising:
a telephony unit for determining a context of the outgoing call;
a plurality of desktop customization units connected to the telephony unit;
wherein the telephony unit activates at least one of the desktop customization units based on the determined context and wherein the activated at least one desktop customization unit customizes the desktop in accordance with the determined context.

53. The apparatus of claim 52 further comprising an IVR unit connected to the telephony unit for prompting the user to select one of a plurality of IVR options, wherein the telephony unit selects which at least one of the desktop customization units to activate based on the IVR option selected by the user.

54. The apparatus of claim 52 wherein the outgoing call includes a call subject line.

55. The apparatus of claim 54 wherein the call subject line is delivered using a method selected from a group of methods consisting of instant messaging, text messaging, and short message service (“SMS”) messaging.

56. The apparatus of claim 54 wherein the telephony unit selects which at least one of the desktop customization units to activate based on a call subject indicated by the call subject line and an identity of a called party.

57. The apparatus of claim 52 wherein the at least one of the desktop customization units comprises an application integration unit for enabling user access to one or more applications.

58. The apparatus of claim 52 wherein the at least one of the desktop customization units comprises a content aggregation unit for aggregating information related to the context and posting the aggregated information on the desktop.

59. The apparatus of claim 52 wherein the at least one of the desktop customization units comprises a team collaboration unit for updating and arranging a user contact list.
